(19) United States
(12) Patent Application Publication
(10) Pub. No.: US 2018/0211408 A1
(43) Pub. Date: Jul. 26, 2018

(54) DISTANCE METER AND DISTANCE MEASURING METHOD

(71) Applicant: REC Technology Corporation, Taoyuan City (TW)

(72) Inventor: Chien-Ming Chen, Taoyuan City (TW)

(73) Assignee: REC Technology Corporation, Taoyuan City (TW)

(21) Appl. No.: 15/468,112

(22) Filed: Mar. 24, 2017

(30) Foreign Application Priority Data
Jan. 20, 2017 (TW) 106102053

(51) Int. Cl. G06T 7/73; H04N 5/232; G01C 3/12

(52) U.S. Cl. CPC G06T 7/73; H04N 5/23229; G06T 2207/30244; G01C 3/12; H04N 5/23293

(57) ABSTRACT

A distance meter is provided. The distance meter includes a lens module, at least one optical functional device, an image sensing device, and a processor. The lens module has a view angle and a central point and receives a main image light of an object and an auxiliary image light of the object. The at least one optical functional device is disposed in the view angle of the lens module. The main image light forms a main image on the image sensing device. The auxiliary image light forms at least one auxiliary image correspondingly on the image sensing device through the at least one optical functional device. The processor is electrically connected to the image sensing device. The processor determines a distance between the object and the central point according to image positions of the main image and the at least one auxiliary image.

### CROSS-REFERENCE TO RELATED APPLICATION

This application claims the priority benefit of Taiwan application serial no. 106102053, filed on Jan. 20, 2017. The entirety of the above-mentioned patent application is hereby incorporated by reference herein and made a part of this specification.

### FIELD OF THE INVENTION

The invention relates to a distance meter and a distance measuring method.

### DESCRIPTION OF RELATED ART

In everyday life, a user often has to determine a distance between the user himself/herself and an object. Usually, the user determines the distance by visual observation; nevertheless, accuracy of visual observation is low. Under many circumstances, visual observation may not satisfy the needs from the user. In conventional techniques, the distance between the user and the object may be measured by an ultrasonic distance meter. Generally, the ultrasonic distance meter sends out sound waves to the object, and then the sound waves are reflected by the object and bounce back to the ultrasonic distance meter. Next, the time difference between the sound waves being sending out and the sound waves bouncing back is measured by the ultrasonic distance meter. The time difference is multiplied by the velocity of the sound waves in the medium and then divided by two. Such that, the distance between the user and the object is calculated accurately. However, when the ultrasonic distance meter is used to measure the distance, the direction of the bouncing-back sound waves is unknown.

In conventional techniques, lenses are commonly used to measure distances as well. For instance, one of the methods to measure distances with lenses is, for example, through the use of dual lenses. The method interprets a distance to an object by simulating angle differences between human eyes and the object. Nevertheless, relatively more cameras (two or more cameras) are required when measuring distances by using dual lenses, and thereby, resulting in an increase in overall costs. Moreover, subsequent costs for repairs are also relatively higher. In addition, differences among these cameras are required to be calibrated or paired when measuring distances by using dual lenses. As a result, more time is needed when measuring distances.

Another method to measure distances through lenses is, for example, through the use of a single lens. The main principle is to focus on an object through a single lens. When the object is most clearly imaged, changes in focal lengths may be converted into a distance. A zoom lens is required to be used when measuring distances through a single lens. Nevertheless, costs of zoom lenses are much higher. In addition, focusing time may vary greatly when affected by differences between software and hardware of the focus system. Focus time may increase and lifetime of the structure may decrease under an unstable environment. Therefore, how to overcome the above problems is one of the major subjects in the industry.

### SUMMARY OF THE INVENTION

The invention provides a distance meter with a simple structure and good portability for measuring a distance between an object and the distance meter accurately.

The invention further provides a distance measuring method for measuring a distance between an object and a distance meter accurately.

In an embodiment of the invention, a distance meter is provided. The distance meter includes a lens module, at least one optical functional device, an image sensing device, and a processor. The lens module has a view angle and a central point and receives a main image light of an object and an auxiliary image light of the object. The at least one optical functional device is disposed in the view angle of the lens module. The main image light forms a main image on the image sensing device. The auxiliary image light forms at least one auxiliary image correspondingly on the image sensing device through the at least one optical functional device. The processor is electrically connected to the image sensing device. The processor determines a distance between the object and the central point according to image positions of the main image and the at least one auxiliary image.

In an embodiment of the invention, a distance measuring method is provided. The distance measuring method includes providing a lens module. The lens module has a view angle and a central point and is configured to receive a main image light of an object and an auxiliary image light of the object. At least one optical functional device is disposed in the view angle of the lens module. An image sensing device is provided. A main image is formed on the image sensing device by the main image light. At least one auxiliary image is formed on the image sensing device by the auxiliary image light through the at least one optical functional device. A distance between the object and the central point is determined according to image positions of the main image and the at least one auxiliary image.

In an embodiment of the invention, the at least one optical functional device contains a plurality of optical functional devices, and the at least one auxiliary image contains a plurality of auxiliary images.

In an embodiment of the invention, the processor determines at least one characteristic triangle according to the image positions of the main image and the at least one auxiliary image and positional relations between the lens module and the at least one optical functional device. The processor determines the distance between the object and the central point according to the at least one characteristic triangle.

In an embodiment of the invention, the at least one optical functional device defines a plurality of angles in the view angle of the lens module. The angles include a main angle and at least one auxiliary angle. The object is located within a range of the main angle, and one optical functional device is located in a range of one auxiliary angle. The auxiliary angle performs mirroring and forms an auxiliary image acquisition angle according to the optical functional device correspondingly located in the auxiliary angle. The auxiliary image acquisition angle and the main angle overlap.

In an embodiment of the invention, the distance meter further includes a user interface. The user interface is electrically connected to the processor. The user interface is configured to display the distance between the object and the central point.

In an embodiment of the invention, when the distance between the object and the central point is less than a default distance, the user interface sends a reminder signal.

In view of the foregoing, in the distance meter provided by the embodiments of the invention, the main image and the at least one auxiliary image are respectively formed by the object through the installation of the lens module and the at least one optical functional device. The main image and the at least one auxiliary image are imaged on the image sensing device. The distance between the object and the central point is then determined by the processor according to the image positions of the main image and the at least one auxiliary image. Compared to conventional techniques, the distance meter provided by the embodiments of the invention has a simple structure and good portability and is able to measure the distance between the object and the distance meter accurately. The distance measuring method provided by the embodiments of the invention is able to measure the distance between the object and the lens module accurately.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view of a distance meter according to an embodiment of the invention.

FIG. 1B is an implementation illustrating a processor in FIG. 1A determines a characteristic triangle.

FIG. 2A is a schematic view of a distance meter according to another embodiment of the invention.

FIG. 2B and FIG. 2C are implementations illustrating a processor in FIG. 2A determines a characteristic triangle.

FIG. 3 is a flowchart of a distance measuring method according to an embodiment of the invention.

### DESCRIPTION OF THE EMBODIMENTS

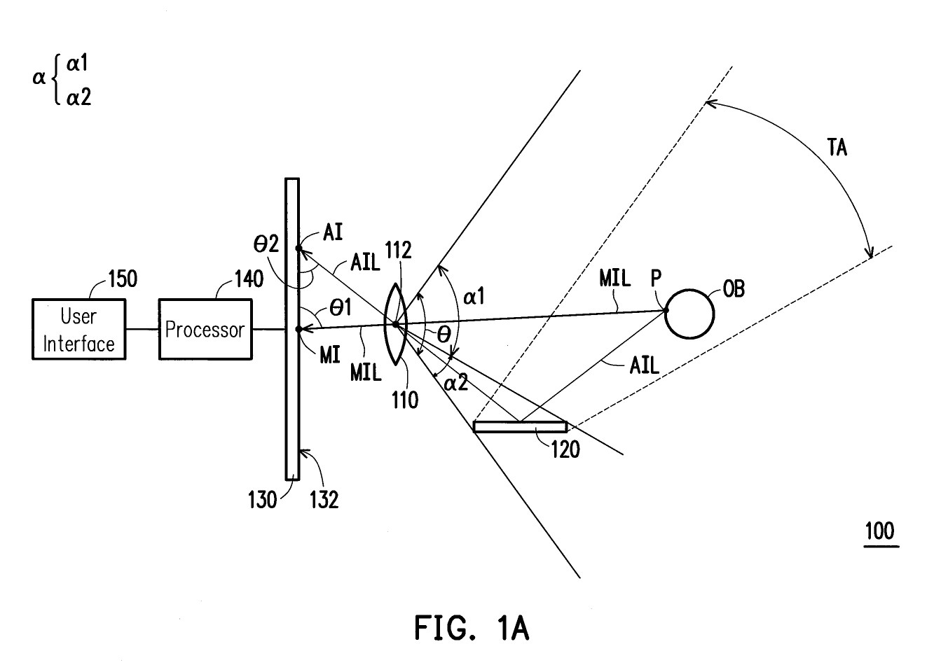

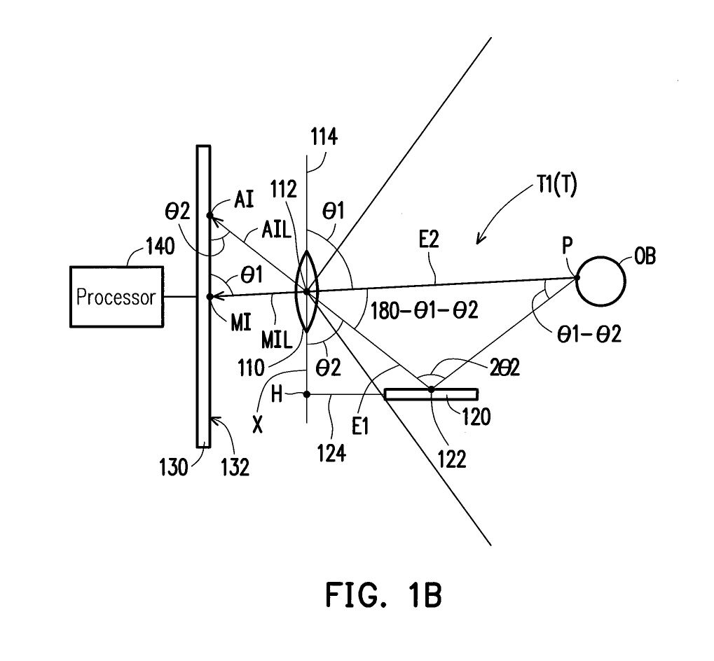

FIG. 1A is a schematic view of a distance meter according to an embodiment of the invention. 0018 FIG. 1B is an implementation illustrating a processor in FIG. 1A determines a characteristic triangle. It should be noted that for the purpose of clear illustrations, only the relations of correspondence among an object, a lens module, an image sensing device, a processor, and a characteristic triangle are illustrated in FIG. 1B.

Referring to FIG. 1A, in the embodiment, a distance meter 100 includes a lens module 110, at least one optical functional device 120, an image sensing device 130, and a processor 140. The lens module 110 has a view angle θ and a central point 112. The lens module 110, for example, includes a plurality of lenses arranged along an optical axis (not shown). In the embodiment, the view angel θ is defined as a range in which the lens module 110 can receive images in an external environment. The at least one optical functional device 120 is disposed in the view angle θ of the lens module 110. Specifically, the optical functional device 120 is located in the view angle θ. In the distance meter 100 in FIG. 1A, the number of the optical functional device 120 is, for example, one, but the invention is not limited thereto. A main image light MIL of a point P on an object OB forms a main image MI on an image plane 132 of the image sensing device 130. An auxiliary image light ALI of the point P of the object OB forms at least one auxiliary image AI correspondingly on the image plane 132 of the image sensing device 130 through the at least one optical functional device 120. The number of the auxiliary image AI is, for example, one, but the invention is not limited thereto. Specifically, the main image light MIL forms the main image MI on the image sensing device 130 directly through the lens module 110. The auxiliary image light AIL of the object OB is first transmitted to the optical functional device 120. Then the optical functional device 120 changes an optical path of the auxiliary image light AIL, such that the auxiliary image light AIL forms the at least one auxiliary image AI on the image sensing device 130 through the lens module 110. The auxiliary image light AIL is, for example, reflected by the optical functional device 120 and thus changes its optical path. In other words, the lens module 110 is optically coupled to the image sensing device 130.

More specifically, the at least one optical functional device 120 defines a plurality of angles α in the view angle θ of the lens module 110. The angles include a main angle α and at least one auxiliary angle α2. Specifically, an angle formed between connecting lines connecting the central point 112 and two opposite ends EN1 and EN2 of the optical functional device 120 is the auxiliary angle α2. The angle containing in the view angle θ in addition to the auxiliary angle α2 is the main angle α1. The object OB is located within a range of the main angle α1, and one optical functional device 120 is located in a range of one auxiliary angle α2. The auxiliary angle α2 performs mirroring and forms an auxiliary image acquisition angle TA according to the optical functional device 120 correspondingly located in the auxiliary angle α2. The auxiliary image acquisition angle TA and the main angle α1 overlap. In other words, in the distance meter 100 provided by the embodiment, the main image MI and the auxiliary image AI correspondingly and respectively formed by the main image light MIL of the object OB and the auxiliary image light AIL of the object OB are imaged on the image sensing device 130 through the installation of the at least one optical functional device 120.

In the embodiment, the image sensing element 130 is, for example, a charge coupled device (CCD) image sensor or a complementary metal-oxide-semiconductor (CMOS) image sensor. The invention is not limited thereto.

In the embodiment, the optical functional device 120 is, for example, a reflector. In other embodiments, the optical functional device 120 is, for example, a refractor. The optical functional device 120 is configured to change a transmission path of an image light of the object OB, such that the object OB forms the auxiliary image AI. Therefore, any types of the optical functional devices 120 that enable the main image MI and the auxiliary image AI formed respectively and correspondingly by the main image light MIL and the auxiliary image light AIL to be formed on the image sensing element 130 falls within the scope of the invention. The optical functional device 120 is not limited to the reflector or the refractor.

Referring to FIG. 1A, in the embodiment, the processor 140 is electrically connected to the image sensing device 130. The processor 140 determines a distance between the object OB and the central point 112 according to image positions of the main image MI and the at least one auxiliary image AI. Detailed descriptions of how the processor 140 determines the distance between the object OB and the central point 112 are as follows.

In the embodiment, since the main image MI and the at least one auxiliary image AI are imaged on the image sensing device 130, the optical functional device 120 and the lens module 110 are positioned in a fixed manner. Referring to FIG. 1B, the optical functional device 120 and the lens module 110 are positioned in a manner that, for example, an extension line 124 of the optical functional device 120 penetrates perpendicularly through a major axis 114 of the lens module 110 and intersects at a point H. Nevertheless, in other embodiments, the extension line 124 of the optical functional device 120 may also not be perpendicular to the major axis 114. The invention is not limited thereto. A distance between the point H and the central point 112 is denoted by X. In other words, a value of X is known and fixed. The processor 140 determines at least one characteristic triangle T according to the image positions of the main image MI and the at least one auxiliary image AI and positional relations between the lens module 110 and the at least one optical functional device 120. Specifically, the processor 140 acquires the image positions of the main image MI and the at least one auxiliary image AI and then forms extension lines extending respectively from the image positions to the central point 112 of the lens module 110 to form two edges E1 and E2 of a characteristic triangle T1. An angle between the two edges E1 and E2 is 180-θ1-θ2. The edge E1 of the characteristic triangle T1 is, for example, a distance between the central point 112 and a point 122 on a surface of the optical functional device 120. The edge E2 of the characteristic triangle T1 is, for example, a distance between the central point 112 and the point P on a surface of the object OB. A length of the edge E1 is shown in the following formula:

E1=X×secθ₂

According to triangulation, it can be seen that a length of the edge E2 is shown in the following formulas:

$$\frac{X \times sec {θ}_{2}}{sin ( {θ}_{1} - {θ}_{2} )} = \frac{{E}_{2}}{sin 2 {θ}_{2}}$$

$${E}_{2} = sin 2 {θ}_{2} \times \frac{X \times sec θ}{sin ( {θ}_{1} - {θ}_{2} )}$$

In the embodiment, the length of the edge E2 is calculated by the processor 140 through, for example, the above calculating method. Such that, the processor 140 determines the distance between the central point 112 and the object OB through calculating the length of the edge E2 of the characteristic triangle T.

It is worth mentioning that in the embodiment, the distance meter 100 further includes a user interface 150. The user interface 150 is electrically connected to the processor 140. The user interface 150 is, for example, a display with audio/video function. The user interface 150 is configured to display the distance between the object OB and the central point 112. Under one circumstance, when the distance between the object OB and the central point 112 is less than a default distance, the user interface 150 sends a reminder signal to inform a user that the distance is too close (i.e., a distance prompt). In the embodiment, the reminder signal is, for example, an alarm sound or an alert signal. In other embodiments, various applications, such as remote object measurement, may be derived for the user interface 150 by applying results of the distance between the object OB and the central point 112. The invention is not limited thereto.

In addition, in the embodiment, the distance meter 100 senses the main image MI and the auxiliary image AI at different time points through the image sensing device 130 to determine the distance between the object OB and the central point 112 at each time point. Moreover, the processor 140 may calculate a relative velocity of the object OB with respect to the distance meter 100 according to the distance between the object OB and the central point 112 at each time point and time differences between time points.

As described above, in the distance meter 100 provided by the embodiment, the object OB respectively forms the main image MI and the at least one auxiliary image AI through the installation of the lens module 110 and the at least one optical functional device 120. The main image MI and the at least one auxiliary image AI are imaged on the image sensing device 130. The processor 140 then determines the distance between the object OB and the central point 112 according to the image positions of the main image MI and the at least one auxiliary image AI. Compared to a conventional ultrasonic distance meter, the distance meter 100 provided by the embodiment has a simple structure and good portability and is able to accurately measure the distance between the object OB and the distance meter 100. Moreover, compared to the conventional technique that measures a distance with dual lenses, the distance meter 100 provided by the embodiment also avoids using relatively more lenses and cameras. Therefore, the distance meter 100 provided by the embodiment has lower production costs as well as lower subsequent costs for repairs. Compared to the conventional technique that measures a distance with a single lens, the distance meter 100 provided by the embodiment does not have to adjust a focal length for acquiring a distance; in other words, a zoom lens which is more expensive is not required. Therefore, the distance meter 100 provided by the embodiment has lower production costs.

It is worth mentioning that the distance meter 100 provided by the embodiment has a simple structure and good portability and thereby may be used in a variety of fields, for example, the fields of vehicle distance measurement and cell phone distance measurement. But the invention is not limited to the fields that the distance meter 100 is applicable to.

It should be explained that a part of the contents in the previous embodiments are used in the following embodiments, in which repeated description of the same technical contents is omitted, and elements which are named identically may be referred the part of the contents. A detailed description will not be repeated in the following embodiments.

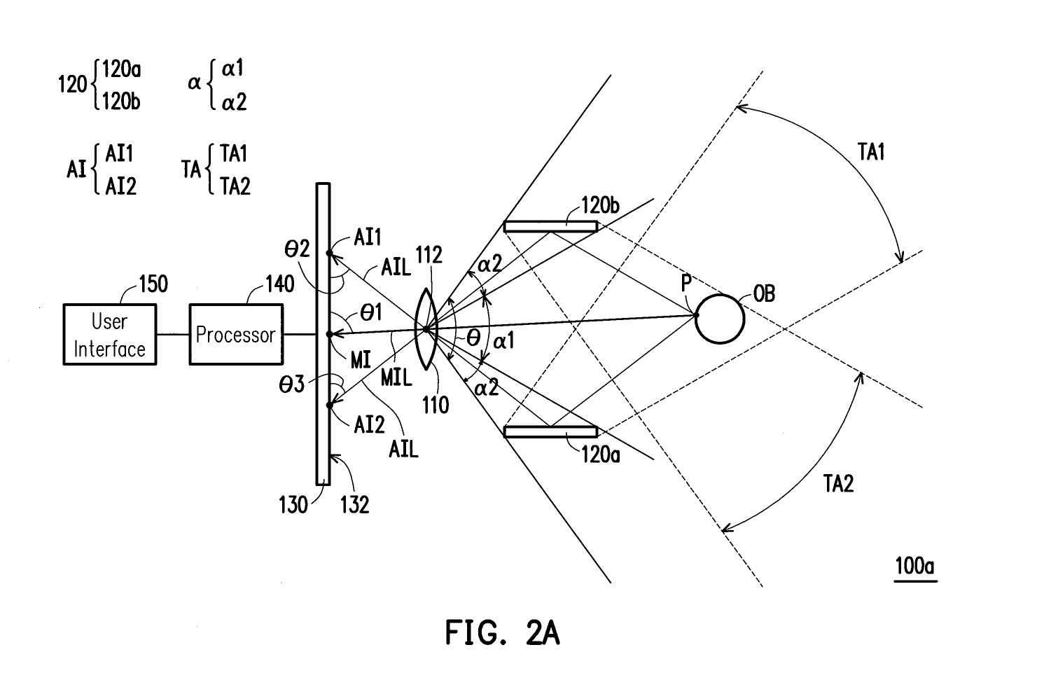

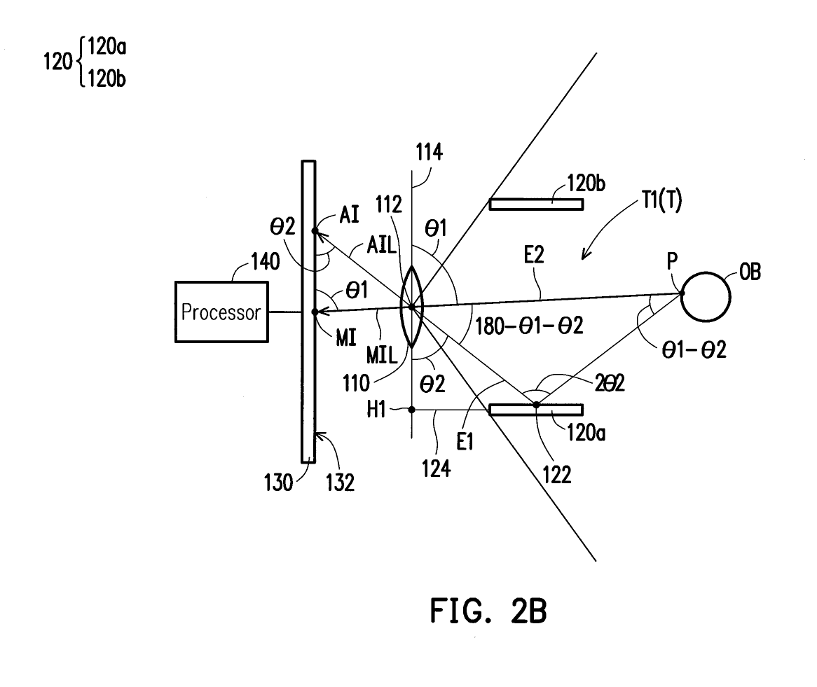

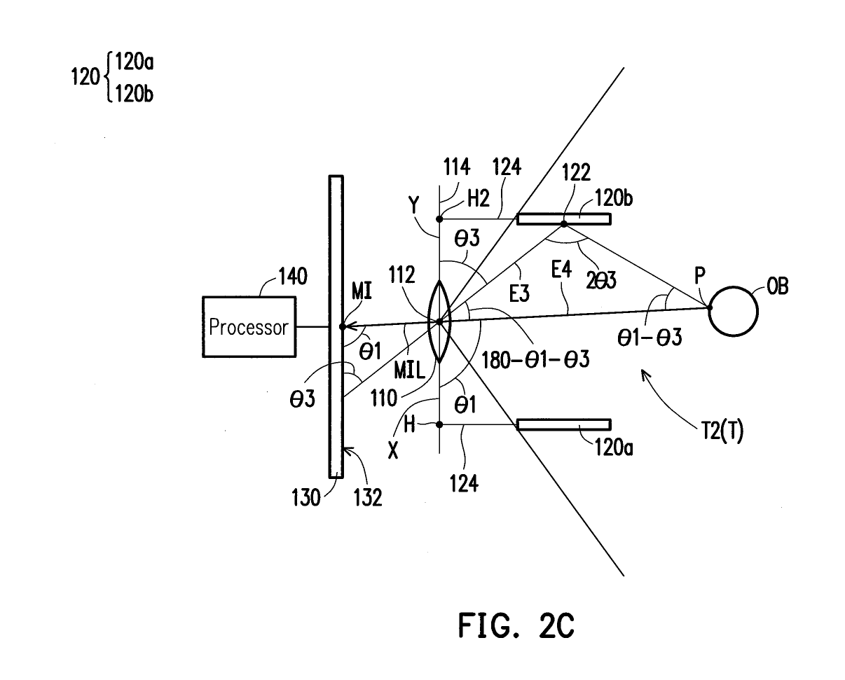

FIG. 2A is a schematic view of a distance meter according to another embodiment of the invention. FIG. 2B and FIG. 2C are implementations illustrating a processor in FIG. 2A determines a characteristic triangle. It should be noted that for the purpose of clear illustrations, only the relations of correspondence among an object, a lens module, an image sensing device, a processor, and a characteristic triangle are illustrated in FIG. 2B and FIG. 2C.

Referring to FIG. 2A and FIG. 2C, a distance meter 100a in FIG. 2A is substantially similar to the distance meter 100 in FIG. 1A. Nevertheless, differences between the distance meter 100a and the distance meter 100 include the at least one optical functional device 120 contains a plurality of optical functional devices 120, and the at least one auxiliary image AI contains a plurality of auxiliary images. Specifically, the number of the optical functional devices 120 is, for example, two, namely an optical functional device 120a and an optical functional device 120b. The number of the auxiliary images AI is, for example, two, namely an auxiliary image AI1 and an auxiliary image AI2. The auxiliary angle α2 performs mirroring and forms an auxiliary image acquisition angle TA1 according to the optical functional device 120a correspondingly located in the auxiliary angle α2. The auxiliary angle α2 performs mirroring and forms an auxiliary image acquisition angle TA2 according to the optical functional device 120b correspondingly located in the auxiliary angle α2. The auxiliary image acquisition angles TA1 and TA2 and the main angle α1 overlap. The processor 140 determines the plural characteristic triangles T according to image positions of the main image MI and the auxiliary images AI. The number of the characteristic triangles T is, for example, two, namely a characteristic triangle T1 (as shown in FIG. 2B) and a characteristic triangle T2 (as shown in FIG. 2C). The formation of the characteristic triangle T1 is similar to that in the embodiment shown in FIG. 1B, a detailed description is thus omitted. Detailed descriptions of the formation of the characteristic triangle T2 are as follows. Specifically, the optical functional device 120b and the lens module 110 are positioned in a manner that, for example, an extension line 122 of the optical functional device 120b penetrates perpendicularly through the major axis 114 of the lens module 110 and intersects at a point H2. Nevertheless, in other embodiments, the extension line 124 of the optical functional device 120b may also not be perpendicular to the major axis 114. The invention is not limited thereto. A distance between the point H2 and the central point 112 is denoted by Y. The processor 140 acquires the image positions of the main image MI and the auxiliary images AI and then forms extension lines extending respectively from the image positions to the central point 112 of the lens module 110 to form two edges E3 and E4 of the characteristic triangle T2. An angle between the two edges E3 and E4 is 180-θ1-θ3. The edge E3 of the characteristic triangle T2 is, for example, the distance between the central point 112 and the point 122 on the surface of the optical functional device 120. The edge E4 of the characteristic triangle T3 is, for example, the distance between the central point 112 and the point P on the surface of the object OB. A length of the edge E3 is shown in the following formula:

E3=Y×secθ

According to triangulation, it can be seen that a length of the edge E4 is shown in the following formulas:

$$\frac{Y \times sec {θ}_{2}}{sin ( {θ}_{1} - {θ}_{3} )} = \frac{{E}_{4}}{sin 2 {θ}_{3}}$$

$${E}_{4} = sin 2 {θ}_{3} \times \frac{X \times sec θ}{sin ( {θ}_{1} - {θ}_{3} )}$$

In the embodiment, the lengths of the edge E2 and the edge E4 are calculated by the processor 140 through, for example, the above calculating method. Such that, the processor 140 determines the distance between the central point 112 and the object OB through calculating the length of the edge E2 of the characteristic triangle T1 and the edge E4 of the characteristic triangle T2. Specifically, the processor 140 determines the distance between the central point 112 and the object OB through averaging the length of the edge E2 and the length of the edge E4. Such that the distance meter 100a in the embodiment may further enhance accuracy of measurement through installing a plurality sets of the optical functional devices 200.

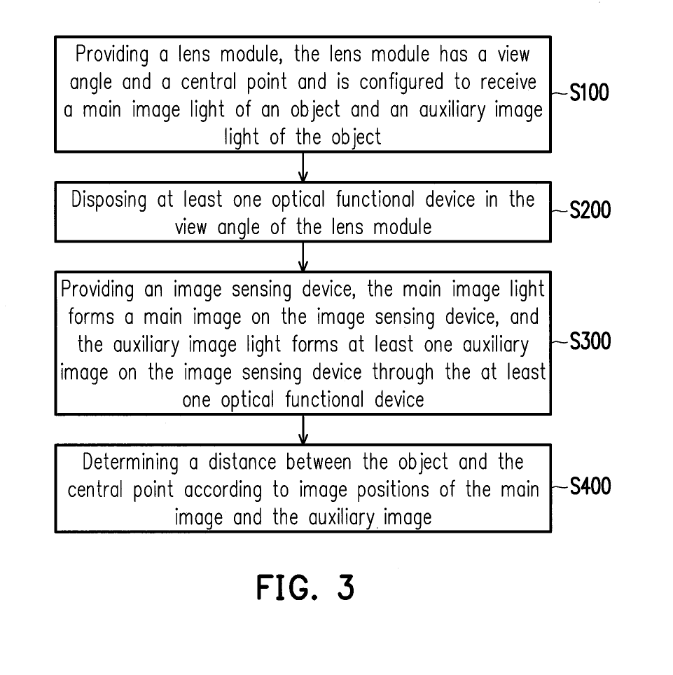

FIG. 3 is a flowchart of a distance measuring method according to an embodiment of the invention. Referring to FIG. 3, in step S100, the lens module 110 is provided. The lens module 110 has the view angle θ and the central point 112 and is configured to receive the main image light MIL of the object OB and the auxiliary image light AIL of the object OB.

In step S200, the at least one optical functional device 120 is disposed in the view angle θ of the lens module 110.

In step S300, the image sensing device 130 is provided. The main image MI is formed on the image sensing device 130 by the main image light MIL. The at least one auxiliary image AI is formed on the image sensing device 130 by the auxiliary image light AIL through the at least one optical functional device 120.

In step S400, the distance between the object OB and the central point 112 is determined according to the image positions of the main image MI and the auxiliary image AI, the at least one characteristic triangle, and the image position of the at least one auxiliary image AI.

In view of the foregoing, in the distance meter and the distance measuring method provided by the embodiments of the invention, the main image and the at least one auxiliary image are respectively formed by the object through the installation of the lens module and the at least one optical functional device. The main image and the at least one auxiliary image are imaged on the image sensing device. The distance between the object and the central point is then determined by the processor according to the image positions of the main image and the at least one auxiliary image. Specifically, the at least one characteristic triangle is determined by the processor according to the image positions of the main image and the at least one auxiliary image. The distance between the object and the central point is further determined by the processor according to the at least one characteristic triangle. Furthermore, in the distance meter and the distance measuring method provided by the embodiments of the invention, accuracy of measurement may be enhanced through installing a plurality sets of the optical functional devices. Therefore, compared to conventional techniques, the distance meter provided by the embodiments of the invention has a simple structure and good portability and is able to measure the distance between the object and the central point of the lens module more accurately. The distance measuring method provided by the embodiments of the invention is able to accurately measure the distance between the object and the central point of the lens module.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A distance meter, comprising:
a lens module, having a view angle and a central point and receiving a main image light of an object and an auxiliary image light of the object;
at least one optical functional device, disposed in the view angle of the lens module;
an image sensing device, the main image light forming a main image on the image sensing device and the auxiliary image light forming at least one auxiliary image correspondingly on the image sensing device through the at least one optical functional device; and
a processor, electrically connected to the image sensing device,
wherein the processor determines a distance between the object and the central point according to image positions of the main image and the at least one auxiliary image.

2. The distance meter as claimed in claim 1, wherein the at least one optical functional device contains a plurality of optical functional devices, and the at least one auxiliary image contains a plurality of auxiliary images.

3. The distance meter as claimed in claim 1, wherein the processor determines at least one characteristic triangle according to the image positions of the main image and the at least one auxiliary image and positional relations between the lens module and the at least one optical functional device, and the processor determines the distance between the object and the central point according to the characteristic triangle.

4. The distance meter as claimed in claim 1, wherein the at least one optical functional device defines a plurality of angles in the view angle of the lens module, the angles comprise a main angle and at least one auxiliary angle, the object is located within a range of the main angle, and one optical functional device is located in a range of the at least one auxiliary angle,
wherein the at least one auxiliary angle performs mirroring and forms an auxiliary image acquisition angle according to the optical functional device correspondingly located in the auxiliary angle, and the auxiliary image acquisition angle and the main angle overlap.

5. The distance meter as claimed in claim 1, wherein a type of the at least one optical functional device is selected from at least one of a reflector and a refractor.

6. The distance meter as claimed in claim 1, further comprising a user interface electrically connected to the processor, wherein the user interface is configured to display the distance between the object and the central point.

7. The distance meter as claimed in claim 6, wherein when the distance between the object and the central point is less than a default distance, the user interface sends a reminder signal.

8. A distance measuring method configured to determine a distance between an object and a lens module, comprising:
providing the lens module, the lens module having a view angle and a central point and configured to receive a main image light of the object and an auxiliary image light of the object;
disposing at least one optical functional device in the view angle of the lens module;
providing an image sensing device, the main image light forming a main image on the image sensing device and the auxiliary image light forming at least one auxiliary image on the image sensing device through the at least one optical functional device; and
determining a distance between the object and the central point according to image positions of the main image and the at least one auxiliary image.

9. The distance measuring method as claimed in claim 8, wherein the at least one optical functional device contains a plurality of optical functional devices, and the at least one auxiliary image contains a plurality of auxiliary images.

10. The distance measuring method as claimed in claim 8, wherein the at least one optical functional device defines a plurality of angles in the view angle of the lens module, the angles comprise a main angle and at least one auxiliary angle, the object is located within a range of the main angle, and one optical functional device is located in a range of the at least one auxiliary angle,
wherein the at least one auxiliary angle performs mirroring and forms an auxiliary image acquisition angle according to the optical functional device correspondingly located in the auxiliary angle, and the auxiliary image acquisition angle and the main angle overlap.

11. The distance measuring method as claimed in claim 8, wherein a type of the at least one optical functional device is selected from at least one of a reflector and a refractor.

12. The distance measuring method as claimed in claim 8, further comprising providing a user interface configured to display the distance between the object and the central point.

13. The distance measuring method as claimed in claim 12, wherein when the distance between the object and the central point is less than a default distance, the user interface sends a reminder signal.
